(19) United States
(12) Patent Application Publication
(10) Pub. No.: US 2025/0187914 A1
(43) Pub. Date: Jun. 12, 2025

(54) METHODS OF TRANSPORTING HYDROGEN THAT INCLUDE HYDROCRACKING AND DEHYDROGENATION AT SEPARATE HYDROCARBON PROCESSING FACILITIES

(71) Applicant: Saudi Arabian Oil Company, Dhahran (SA)

(72) Inventors: Guanghui Zhu, Dhahran (SA); Raed H. Abudawoud, Dhahran (SA); Faisal M. Almulla, Dhahran (SA); Anas S. Al-Aqeeli, Dhahran (SA)

(73) Assignee: Saudi Arabian Oil Company, Dhahran (SA)

(21) Appl. No.: 18/530,490

(22) Filed: Dec. 6, 2023

(51) Int. Cl. C01B 3/26; C10G 69/04

(52) U.S. Cl. CPC C01B 3/26; C10G 69/04; C01B 2203/0277; C01B 2203/062; C01B 2203/1247; C01B 2203/1264; C10G 2300/1044; C10G 2300/1051; C10G 2300/1055; C10G 2300/107; C10G 2300/1074; C10G 2300/42

(57) ABSTRACT

In some embodiments, a method of transporting hydrogen, may comprise: at a first hydrocarbon processing facility, hydrocracking a hydrocarbon feed to form a hydrocracked effluent, transporting the hydrocracked effluent, or a portion thereof, from the first hydrocarbon processing facility to a second hydrocarbon processing facility, and at the second hydrocarbon processing facility, dehydrogenating a portion of the hydrocracked effluent to form hydrogen gas. The first hydrocarbon processing facility and the second hydrocarbon processing facility may be at least 100 km apart from one another.

### TECHNICAL FIELD

Embodiments of the present disclosure generally relate to hydrogen processing, and more specifically, to methods and systems utilized to transport hydrogen.

### BACKGROUND

Hydrogen is growing in importance as an environmentally friendly precursor chemical and fuel. Processes for the production and usage of hydrogen are relatively well developed. However, processes for the storage and transportation of hydrogen are still insufficient to meet the needs of the hydrogen industry. Generally, hydrogen is stored and transported in the form of compressed gaseous hydrogen molecules (e.g., at above 5,000 pounds per square inch). However, these conventional gaseous hydrogen transportation techniques are costly and inefficient. For example, the compression process consumes a large amount of energy (estimated to be 30% or more of the energy content of the hydrogen). Also, transport and storage of the compressed hydrogen requires expensive pressure vessels. Some of the hydrogen molecules can even escape through the walls of hydrogen containment vessels. The hydrogen can also cause embrittlement of the storage and transport vessels. Overall, better methods of hydrogen storage and transport are needed.

### BRIEF SUMMARY

Embodiments of the present disclosure provide methods of transporting hydrogen by hydrocracking a hydrocarbon feed at a first hydrocarbon processing facility to produce a hydrocracked effluent, and then transporting all or a portion of the hydrocracked effluent to a second hydrocarbon processing facility where the hydrocracked effluent is dehydrogenated. For example, a crude oil cut, such as vacuum gas oil, may be utilized as a hydrocarbon feed, where a portion or all of the vacuum gas oil is reacted with hydrogen in a hydrocracking reaction to form a hydrocracked effluent that is more easily transportable than hydrogen gas. Generally, this hydrogenated effluent is a liquid, or is easier to liquefy than hydrogen. Then, the hydrocracked effluent may be transported to the second hydrocarbon processing facility where it is dehydrogenated to form a valuable petrochemical product along with hydrogen. The hydrogen is, thus, transported between hydrocarbon processing facility, and valuable petrochemical products are also formed at the second site that can be locally consumed or sold. In such embodiments, hydrogen may be transported over vast distances, such as between countries or continents, without the need for costly hydrogen gas pressurization. Also, contemplated herein are embodiments where the hydrocracked effluent is separated into multiple streams at the first hydrocarbon processing facility or at the second hydrocarbon processing facility, as is described in detail herein.

According to one or more embodiments, a method of transporting hydrogen may comprise, at a first hydrocarbon processing facility, hydrocracking a hydrocarbon feed in the presence of hydrogen gas to form a hydrocracked effluent, separating the hydrocracked effluent into two or more hydrogenated hydrocarbon cuts; transporting one or more of the hydrogenated hydrocarbon cuts from the first hydrocarbon processing facility to a second hydrocarbon processing facility, and, at the second hydrocarbon processing facility, dehydrogenating one or more of the hydrogenated hydrocarbon cuts to form hydrogen gas and one or more dehydrogenated hydrocarbon cuts. The hydrocracked effluent may have a greater ratio of hydrogen to carbon than the hydrocarbon feed. The first hydrocarbon processing facility and the second hydrocarbon processing facility may be at least 100 km apart from one another.

According to one or more embodiments, a method of transporting hydrogen may comprise, at a first hydrocarbon processing facility, hydrocracking a hydrocarbon feed in the presence of hydrogen gas to form a hydrocracked effluent, separating the hydrocracked effluent into at least a hydrogen recycle stream comprising hydrogen gas and a heavy hydrocarbon stream comprising C₅₊ hydrocarbons; transporting the heavy hydrocarbon stream from the first hydrocarbon processing facility to a second hydrocarbon processing facility, separating the heavy hydrocarbon stream into two or more hydrogenated hydrocarbon cuts; and at the second hydrocarbon processing facility, and dehydrogenating one or more of the hydrogenated hydrocarbon cuts to form hydrogen gas and one or more dehydrogenated hydrocarbon cuts. The hydrocracked effluent may have a greater ratio of hydrogen to carbon than the hydrocarbon feed, The first hydrocarbon processing facility and the second hydrocarbon processing facility may be at least 100 km apart from one another; at the second hydrocarbon processing facility,

These and other embodiments are described in more detail in the Detailed Description. It is to be understood that both the foregoing general description and the following detailed description present embodiments of the presently disclosed technology, and are intended to provide an overview or framework for understanding the nature and character of the technology as it is claimed. The accompanying drawings are included to provide a further understanding of the presently disclosed technology and are incorporated into and constitute a part of this specification. The drawings illustrate various embodiments and, together with the description, serve to explain the principles and operations of the presently disclosed technology. Additionally, the drawings and descriptions are meant to be merely illustrative, and are not intended to limit the scope of the claims in any manner.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 schematically depicts a diagram of a system for transporting hydrogen, according to one or more embodiments described in this disclosure;

FIG. 2 schematically depicts a diagram of another system for transporting hydrogen, according to one or more embodiments described in this disclosure;

FIG. 3 schematically depicts a diagram of yet another system for transporting hydrogen, according to one or more embodiments described in this disclosure;

FIG. 4 schematically depicts a diagram of yet another system for transporting hydrogen, according to one or more embodiments described in this disclosure;

FIG. 5 schematically depicts a diagram of yet another system for transporting hydrogen, according to one or more embodiments described in this disclosure; and

FIG. 6 schematically depicts a diagram of yet another system for transporting hydrogen, according to one or more embodiments described in this disclosure.

For the purpose of describing the simplified schematic illustrations and descriptions of the relevant figures, the numerous valves, temperature sensors, electronic controllers and the like that may be employed and well known to those of ordinary skill in the art of certain chemical processing operations are not included. Further, accompanying components that are often included in typical chemical processing operations, such as air supplies, catalyst hoppers, and flue gas handling systems, are not depicted. However, operational components, such as those described in the present disclosure, may be added to the embodiments described in this disclosure.

It should further be noted that arrows in the drawings refer to process streams. However, the arrows may equivalently refer to transfer lines which may serve to transfer process streams between two or more system components. Additionally, arrows that connect to system components define inlets or outlets in each given system component. The arrow direction corresponds generally with the major direction of movement of the materials of the stream contained within the physical transfer line signified by the arrow. Furthermore, arrows which do not connect two or more system components signify a product stream which exits the depicted system or a system inlet stream which enters the depicted system. Product streams may be further processed in accompanying chemical processing systems or may be commercialized as end products. System inlet streams may be streams transferred from accompanying chemical processing systems or may be non-processed feedstock streams. Some arrows may represent recycle streams, which are effluent streams of system components that are recycled back into the system. However, it should be understood that any represented recycle stream, in some embodiments, may be replaced by a system inlet stream of the same material, and that a portion of a recycle stream may exit the system as a system product.

Additionally, arrows in the drawings may schematically depict process steps of transporting a stream from one system component to another system component. For example, an arrow from one system component pointing to another system component may represent “passing” a system component effluent to another system component, which may include the contents of a process stream “exiting” or being “removed” from one system component and “introducing” the contents of that product stream to another system component. It should be understood that arrows in the relevant figures are not indicative of necessary or essential steps.

It should be understood that according to the embodiments presented in the relevant figures, an arrow between two system components may signify that the stream is not processed between the two system components. In other embodiments, the stream signified by the arrow may have substantially the same composition throughout its transport between the two system components. Additionally, it should be understood that in one or more embodiments, an arrow may represent that at least 75 wt. %, at least 90 wt. %, at least 95 wt. %, at least 99 wt. %, at least 99.9 wt. %, or even 100 wt. % of the stream is transported between the system components. As such, in some embodiments, less than all of the streams signified by an arrow may be transported between the system components, such as if a slip stream is present.

It should be understood that two or more process streams are “mixed” or “combined” when two or more lines intersect in the schematic flow diagrams of the relevant figures. Mixing or combining may also include mixing by directly introducing both streams into a like reactor, separation device, or other system component. For example, it should be understood that when two streams are depicted as being combined directly prior to entering a separation unit or reactor, that in some embodiments the streams could equivalently be introduced into the separation unit or reactor and be mixed in the reactor.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

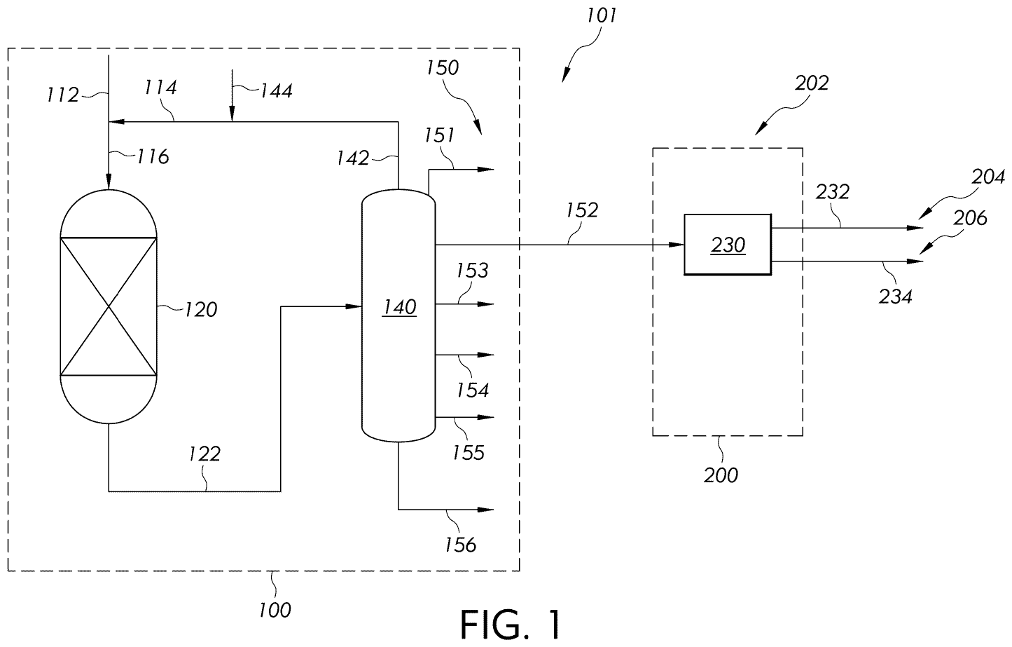

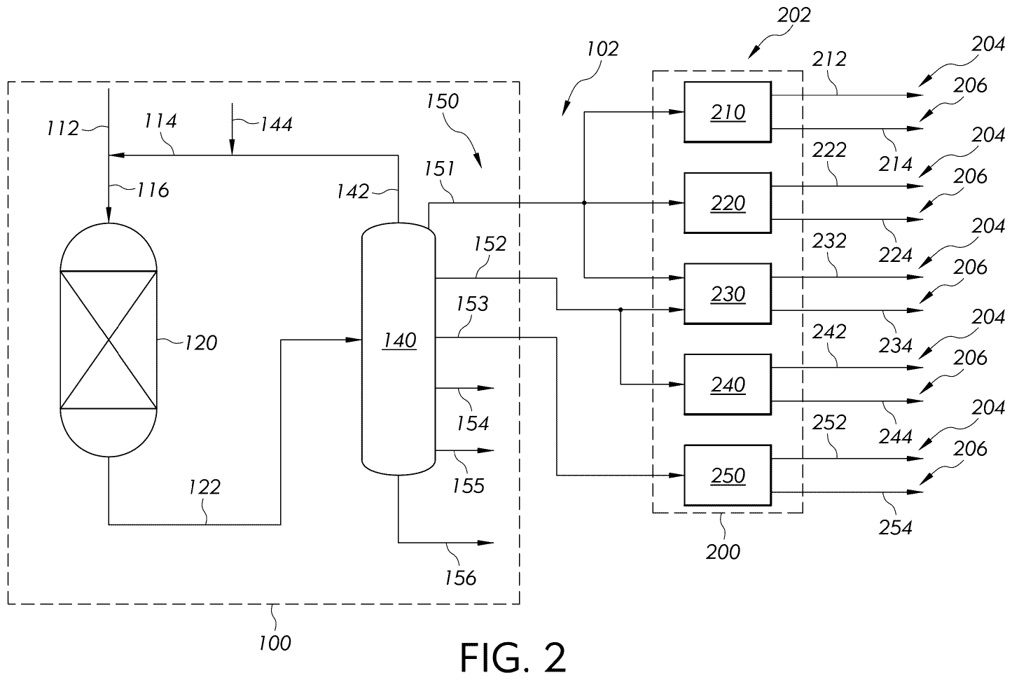

One or more embodiments of the present disclosure relate to methods for transporting hydrogen gas from one geographic region to another. In general, these methods are described herein in the context of one or more systems, shown in the drawings. As is discussed herein, the hydrogen transport systems utilize methods that may transport hydrogen by reacting hydrogen with hydrocarbon feeds to produce hydrocracked effluents, then transporting the hydrogen in the form of hydrocracked effluent or hydrogenated hydrocarbon cuts derived from the hydrocracked effluents, and then releasing the stored hydrogen by dehydrogenation. The embodiments of FIGS. 1-6 are similar or identical in many ways, respectively, but include differences as described herein. Description of the embodiments of FIGS. 1-6 may generally apply to the embodiments of the other figures, as would be understood by those skilled in the art. For example, concepts disclosed herein applicable to FIG. 1 may be equally applicable to FIG. 2, and vice versa, even if not explicitly stated as such herein.

As used in this disclosure, a “catalyst” refers to any substance which increases the rate of a specific chemical reaction. Catalysts described in this disclosure may be utilized to promote various reactions, such as, but not limited to, hydrocracking and dehydrogenation reactions. As used in this disclosure, a “hydrocracking catalyst” increases the rate of a hydrocracking reaction. As used in this disclosure, a “dehydrogenation catalyst” increases the rate of a dehydrogenation reaction. The methods described herein should not necessarily be limited by specific catalytic materials unless explicitly stated as such.

As used in this disclosure, a “separation unit” refers to any separation device or system of separation devices that at least partially separates one or more chemicals that are mixed in a process stream from one another. For example, a separation unit may selectively separate differing chemical species, phases, or sized material from one another, forming one or more chemical fractions. Examples of separation units include, without limitation, distillation columns, flash drums, knock-out drums, knock-out pots, centrifuges, cyclones, filtration devices, traps, scrubbers, expansion devices, membranes, solvent extraction devices, and the like. It should be understood that separation processes described in this disclosure may not completely separate all of one chemical constituent from all of another chemical constituent. It should be understood that the separation processes described in this disclosure “at least partially” separate different chemical components from one another, and that even if not explicitly stated, it should be understood that separation may include only partial separation.

As used in this disclosure, “cracking” refers to a chemical reaction where a molecule having carbon-carbon bonds is broken into more than one molecule by the breaking of one or more of the carbon-carbon bonds; where a compound including a cyclic moiety, such as an aromatic, is converted to a compound that does not include a cyclic moiety; or where a molecule having carbon-carbon double bonds are reduced to carbon-carbon single bonds. Some catalysts may have multiple forms of catalytic activity, and calling a catalyst by one particular function does not render that catalyst incapable of being catalytically active for other functionality. In general, “hydrocracking” refers to cracking in the presence of hydrogen.

Now referring to FIG. 1, a hydrogen transport system 101 is depicted. The hydrogen transport system 101 may include at least a first hydrocarbon processing facility 100 and a second hydrocarbon processing facility 200, where the first hydrocarbon processing facility 100 and a second hydrocarbon processing facility 200 are in different geographic locations, as described herein. In general, a single hydrocarbon processing facility, such as the first hydrocarbon processing facility 100 and a second hydrocarbon processing facility 200, may be a processing facility that is only locally integrated with other processing facilities, and generally refers to an integrated complex capable of transforming its respective hydrocarbon feedstock into its respective products. For example, a single hydrocarbon processing facility may be under the control of a single entity, such as a company. In embodiments, each of the first hydrocarbon processing facility 100 and the second hydrocarbon processing facility 200 may independently be oil refineries. For example, the first hydrocarbon processing facility 100 and a second hydrocarbon processing facility 200 may be oil refineries, respectively, that are in different geographic regions, such as different states, countries, counties, provinces, continents, etc.

The first hydrocarbon processing facility 100 and the second hydrocarbon processing facility 200 may be separate from one another and in different geographic regions. For example, the first hydrocarbon processing facility 100 and the second hydrocarbon processing facility 200 may be at least 100 km apart from one another, such as at least 200 km apart from one another, at least 500 km apart from one another, or at least 1000 km apart from one another.

The physical distance between the first hydrocarbon processing facility 100 and the second hydrocarbon processing facility 200 may make conventional transportation of hydrogen between the first hydrocarbon processing facility 100 and the second hydrocarbon processing facility 200 difficult and/or costly. Use of the present methods and systems may allow cheaper and more efficient transport of hydrogen between the first hydrocarbon processing facility 100 and the second hydrocarbon processing facility 200, thereby allowing an operator to take advantage of cheaper and/or renewable sources of electricity available near the first hydrocarbon processing facility 100 to form hydrogen. In some embodiments, the first hydrocarbon processing facility 100 and the second hydrocarbon processing facility 200 may be located at different latitudes, which may allow the operator to take advantage of variations in energy production, such as the increased production of electricity of a given solar panel when placed closer to the equator.

Still referring to FIG. 1, in one or more embodiments, a hydrocarbon feed stream 112 may be utilized in hydrogen transport system 101 and passed to a hydrocracker 120. The hydrocarbon feed stream 112 may comprise a crude oil or a crude oil distillate fraction, such as naphtha, jet-fuel range hydrocarbons, diesel range hydrocarbons, an atmospheric bottoms stream, or a vacuum gas oil. In embodiments, the hydrocarbon feed stream 112 may have an initial boiling point of from 80° C. to 160° C., such as from 85° C. to 90° C., from 90° C. to 95° C., from 95° C. to 100° C., from 100° C. to 120° C., from 120° C. to 140°, from 140° C. to 160° C., or any combination of one or more of these ranges. In embodiments, the hydrocarbon feed stream 112 may have a final boiling point of from 500° C. to 700° C., such as from 500° C. to 550° C., from 550° C. to 600° C., from 600° C. to 650° C., from 650° C. to 700° C., or any combination of one or more of these ranges. In embodiments, the hydrocarbon feed stream 112 (such as a hydrocarbon feed stream comprising light naphtha) may have an initial boiling point of (IBP) of from 20° C. to 50° C., such as from 20° C. to 30° C., from 30° C. to 40° C., from 40° C. to 50° C., from 25° C. to 35° C., or any combination of one or more of these ranges. The hydrocarbon feed stream 112 (such as a hydrocarbon feed stream comprising light naphtha) may have a final boiling point (FBP) of from 70° C. to 110° C., such as from 70° C. to 80° C., from 80° C. to 90° C., from 90° C. to 100° C., from 100° C. to 110° C., or any combination of one or more of these ranges. In embodiments, the hydrocarbon feed stream 112 (such as a hydrocarbon feed stream comprising heavy naphtha) may have an initial boiling point of (IBP) of from 80° C. to 100° C., such as from 85° C. to 90° C., from 90° C. to 95° C., from 95° C. to 100° C., from 88° C. to 92° C., or any combination of one or more of these ranges. The hydrocarbon feed stream 112 (such as a hydrocarbon feed stream comprising heavy naphtha) may have a final boiling point (FBP) of from 180° C. to 220° C., such as from 190° C. to 220° C., from 200° C. to 220° C., from 210° C. to 220° C., from 195° C. to 205° C., or any combination of one or more of these ranges. In embodiments, the hydrocarbon feed stream 112 (such as a hydrocarbon feed stream comprising jet fuel or diesel range hydrocarbons) may have an initial boiling point of 140° C. to 160° C., such as from 140° C. to 145° C., from 145° C. to 150° C., from 150° C. to 155° C., from 155° C. to 160°, or any combination of one or more of these ranges; and a final boiling point of from 340° C. to 380° C., such as from 340° C. to 350° C., from 350° C. to 360° C., from 360° C. to 370° C., from 370° C. to 380° C., or any combination of one or more of these ranges. In embodiments, the hydrocarbon feed stream 112 (such as a hydrocarbon feed stream comprising vacuum gas oil or atmospheric bottoms stream) may have an initial boiling point of greater than 300° C., such from 300° C. to 400° C., such as from 300° C. to 325° C., from 325° C. to 350° C., from 350° C. to 375° C., or from 375° C. to 400° C., or any combination of one or more of these ranges. In embodiments, the hydrocarbon feed stream 112, may have an end boiling point of from 500° C. to 700° C., such as from 500° C. to 550° C., from 550° C. to 600° C., from 600° C. to 650° C., from 650° C. to 700° C., or any combination of one or more of these ranges.

In some embodiments, the hydrocarbon feed stream 112 may comprise C4-C7 hydrocarbons. In some embodiments, the hydrocarbon feed stream 112 may comprise at least 50 wt. %, at least 60 wt. %, at least 70 wt. %, at least 80 wt. %, at least 90 wt. %, at least 95 wt. %, or at least 99 wt. % of C4-C7 hydrocarbons. The C4-C7 hydrocarbons may comprise alkanes. In some embodiments, the hydrocarbon feed stream may comprise light naphtha.

In some embodiments, the hydrocarbon feed stream 112 is vacuum gas oil. Vacuum gas oil may be produced from a crude oil. In embodiments, the process for producing the hydrocarbon feed stream 112 that is vacuum gas oil from crude oil may comprise introducing the crude oil into an atmospheric distillation unit to produce atmospheric distillate and an atmospheric bottoms stream, recovering the atmospheric bottoms stream from the atmospheric distillation unit, and introducing the atmospheric residue as a feedstock into a vacuum distillation unit to produce vacuum gas oil (not shown in the figures). Other cuts of crude oil may be utilized as the hydrocarbon feed stream 112, such as other refinery cuts from the atmospheric distillation column or the vacuum distillation column.

In embodiments, the hydrocarbon feed stream 112 may comprise a whole crude oil. The crude oil may be a raw hydrocarbon which has not been previously processed, such as through one or more of distillation, cracking, hydroprocessing, desalting, or dehydration. In embodiments, the crude oil may have undergone at least some processing, such as desalting, solids separation, scrubbing, desulfurization, or combinations of these, but has not been subjected to distillation. For instance, the crude oil may be a de-salted crude oil that has been subjected to a de-salting process. In embodiments, crude oil may not have undergone pretreatment, separation (such as distillation), or other operation that changes the hydrocarbon composition of the crude oil prior to introducing the crude oil to the process. As used herein, the “hydrocarbon composition” of the crude oil refers to the composition of the hydrocarbon constituents of the crude oil and does not include entrained non-hydrocarbon solids, salts, water, or other non-hydrocarbon constituents.

Streams from other processes having a boiling range in the defined region may also be blended with hydrocarbon streams (such as vacuum gas oil) to produce the hydrocarbon feed stream 112. For example, heavy coker gas oil may be blended with vacuum gas oil to produce the hydrocarbon feed stream 112.

Still referring to FIG. 1, the first hydrocarbon processing facility 100 may comprise a hydrocracker 120 and a separation unit 140, and the second hydrocarbon processing facility 200 may comprise a steam cracker 230. These system components and their various arrangements will be described in detail herein.

According to one or more embodiments, at the first hydrocarbon processing facility 100, combined hydrogen feed 114 and hydrocarbon feed stream 112 may be passed to the hydrocracker 120. The combined hydrogen feed 114 may be a combination of a hydrogen recycle stream 142 and a makeup hydrogen stream 144, as discussed herein in detail. The combined hydrogen feed 114 and the hydrocarbon feed stream 112 may be combined before being introduced to the hydrocracker 120, thereby forming combined feed 116. Alternatively, combined hydrogen feed 114 and hydrocarbon feed stream 112 may be introduced to the hydrocracker 120 directly, and combined therein. In the hydrocracker 120, the combined hydrogen feed 114 and the hydrocarbon feed stream 112 may be converted to the hydrocracked effluent 122.

The hydrocracker 120 may contact the hydrocarbon feed stream 112 with hydrogen and a hydrocracking catalyst to form the hydrocracked effluent 122. The hydrocracker 120, such as a naphtha or vacuum gas oil hydrocracker 120, may be operated at a temperature of from 300° C. to 450° C., and with a liquid hourly space velocity (LHSV) of 0.3 to 2.0 h⁻¹. The hydrocracker 120 may be a fixed bed reactor, a slurry bed reactor, or an ebullated bed reactor. Typically, a slurry bed reactor may be operated at a temperature of from 400° C. to 460° C. and a pressure of at least 150 bar. Typically, a fixed bed or an ebullated bed reactor may be operated at a temperature of from 350° C. to 600° C. and a pressure of from 10 to 140 bar. Typically, a fixed bed or an ebullated bed reactor may be operated with a hydrocracking catalyst which may comprise Ni/Mo or Ni/W metals, however, the use of other metals such as Pd, Pt, Ir, Rh, Co, Ni, and the like are also contemplated. The metals may be supported on a zeolite, such as ZSM-5, ultra-stable Y (USY)-zeolite or Beta-zeolite. Generally, the ZSM-5 catalyst support may be suitable for use with at least naphtha feedstocks and the Beta-zeolite catalyst support may be suitable for use with at least heavier feedstocks, such as atmospheric residue and vacuum gas oil. Typically, a slurry bed reactor may be operated with a hydrocracking catalyst which may comprise metal sulfides (such as MoS₂). Typically a hydrocracking catalyst in a fixed-bed reactor may comprise particles from 1.2 mm to 3.0 mm in diameter, a hydrocracking catalyst in an ebullated bed reactor may comprise particles about less than 1 mm in diameter, and a hydrocracking catalyst in a slurry bed reactor may comprise particles with diameters in the micron range.

The hydrocracked effluent 122 may have a greater ratio of hydrogen to carbon than the hydrocarbon feed stream 112. For example, the degree of saturation of the hydrocarbons in the hydrocracked effluent 122 may be higher than the degree of saturation in the hydrocarbon feed stream 112, the average molecular weight of the hydrocarbons in the hydrocracked effluent 122 may be lower than the average molecular weight of the hydrocarbons in the hydrocarbon feed stream 112, or both. Thus, hydrogen atoms from hydrogen gas in combined feed 116 are incorporated into the hydrocarbons in the hydrocracked effluent 122.

The hydrocracked effluent 122 may comprise light gas, light naphtha, heavy naphtha, jet fuel range hydrocarbons, diesel range hydrocarbons, and/or unconverted oil. Still referring to FIG. 1, the hydrocracked effluent 122 may be passed to a separation unit 140. The separation unit 140 may separate the hydrocracked effluent 122 into the two or more hydrogenated hydrocarbon cuts 150. The separation unit 140 may be any suitable separation unit, such as, and without limitation, a series of flash vessels or a fractionator/distillation column that separates feedstock based on the boiling point.

In embodiments, the separation unit 140 may separate the hydrocracked effluent 122 into one or more of a light gas stream 151, a light naphtha stream 152, a heavy naphtha stream 153, a jet fuel stream 154, a diesel stream 155, and an unconverted oil stream 156. The light gas stream 151 may comprise C₁-C₄ hydrocarbons, such as at least 80 wt. %, at least 90 wt. %, or at least 99 wt. % of C₁-C₄ hydrocarbons, on the basis of the total weight of the light gas stream 151. The light naphtha stream 152 may comprise C₅ to C₆ hydrocarbons, such as at least 80 wt. %, at least 90 wt. %, or at least 99 wt. % of C₅ to C₆ hydrocarbons, on the basis of the total weight of the light naphtha stream 152. The heavy naphtha stream 153 may comprise C₆ to C₁₂ hydrocarbons, such as at least 80 wt. %, at least 90 wt. %, or at least 99 wt. % of C₆ to C₁₂ hydrocarbons, on the basis of the total weight of the heavy naphtha stream 153. The jet fuel stream 154 may comprise hydrocarbons boiling from 153° C. to 293° C., such as at least 80 wt. %, at least 90 wt. %, or at least 99 wt. % of hydrocarbons boiling from 153° C. to 293° C., on the basis of the total weight of the jet fuel stream 154. The diesel stream 155 may comprise hydrocarbons boiling from 163° C. to 357° C., such as at least 80 wt. %, at least 90 wt. %, or at least 99 wt. % of hydrocarbons boiling from 163° C. to 357° C., on the basis of the total weight of the diesel stream 155. The unconverted oil stream 156 may comprise unconverted oils, such as at least 80 wt. %, at least 90 wt. %, at least 95 wt. %, or at least 99 wt. % of unconverted oils, on the basis of the total weight of the unconverted oil stream 156. The unconverted oil stream 156 may be recycled back to the hydrocracker 120.

Still referring to FIG. 1, a hydrogen recycle stream 142 may be separated from the hydrocracked effluent 122. For example, separation unit 140 may separate the hydrogen recycle stream 142 from the hydrocracked effluent 122. The hydrogen recycle stream 142 may be combined with a makeup hydrogen stream 144 to form combined hydrogen feed 114. Makeup hydrogen stream 144 may comprise hydrogen produced from hydrocarbons, hydrogen produced from renewable sources (hydrogen produced from water electrolysis using electricity produced from sources other than the combustion of hydrocarbons), or both.

At least one of the hydrogenated hydrocarbon cuts 150 may be transported from the first hydrocarbon processing facility 100 to the second hydrocarbon processing facility 200. For example, and as is shown in FIG. 1, the light naphtha stream 152 may be transported from the first hydrocarbon processing facility 100 to the second hydrocarbon processing facility 200. Transporting may refer to the process of physically moving hydrocarbons, to the process of preparing the hydrocarbons to be physically moved, and to storing the hydrocarbons during transportation (such as at an intermediate warehouse away from the first hydrocarbon processing facility 100 or on a tanker ship) from the first hydrocarbon processing facility 100 to the second hydrocarbon processing facility 200. Where hydrogen is transported, as described herein, the hydrogen may be transported in the form of hydrogen atoms covalently bonded to hydrocarbon molecules.

In embodiments, transporting the at least one of the hydrogenated hydrocarbon cuts 150 may comprise transporting the at least one of the hydrogenated hydrocarbon cuts 150 from the first hydrocarbon processing facility 100 to the second hydrocarbon processing facility 200 by tanker truck, train, ship, pipeline, or the like. In embodiments, the hydrocarbons may be transported from the first hydrocarbon processing facility 100 to the second hydrocarbon processing facility 200 by tanker truck, train, and/or ship. A time of at least 2 weeks, such as at least 1 month, at least 2 months, or at least 6 months, may pass between hydrocracking the hydrocarbon feed stream 112 and dehydrogenating the one or more hydrogenated hydrocarbon cuts 150. The transportation step may include storing the hydrocarbons at the first hydrocarbon processing facility 100, the second hydrocarbon processing facility 200, at an intermediate storage or processing facility, or in the transportation vessel itself. The temporal difference between the hydrocracking and dehydrogenating steps may allow the operator to store intermittent electricity in the form of hydrogen for use during times of higher demand, such as storing summer solar power for winter.

Still referring to FIG. 1, at the second hydrocarbon processing facility 200, the hydrogenated hydrocarbon cut 150 may be dehydrogenated in a dehydrogenation unit 202 (such as in a dehydrogenator), thereby forming hydrogen and a dehydrogenated hydrocarbon cut. For example, the light naphtha stream 152 may be dehydrogenated in a steam cracker 230, thereby forming a hydrogen gas stream 232 and a steam cracked stream 234.

Dehydrogenating the one or more hydrogenated hydrocarbon cuts 150 refers to the process of removing hydrogen atoms from a hydrocarbon molecule. Dehydrogenation produces hydrogen gas, which may be separated to form a hydrogen gas stream 212. The hydrogen gas stream 212 may be stored and sent to uses external to the refinery or may be sent to a refinery process unit. Suitable refinery process units include, for example, hydrotreaters, hydrocrackers, hydroprocessors, isomerization units, and catalytic reformers.

As described herein, in some embodiments a steam cracker 230 is utilized. Steam cracking refers to the process of cracking and dehydrogenating hydrocarbons by contacting the hydrocarbons with steam. Generally, steam cracking produces both cracked hydrocarbons and hydrogen. The steam cracker 230 may include a convection zone and a pyrolysis zone downstream of the convection zone. The hydrocarbons may pass into the convection zone with steam. In the convection zone, the hydrocarbons may be pre-heated to a desired temperature, such as from 400° C. to 650° C. The pre-head hydrocarbons may then be passed to the pyrolysis zone, where they may be steam-cracked. According to one or more embodiments, the pyrolysis zone may operate at a temperature of from 700° C. to 900° C. The pyrolysis zone may operate with a residence time of from 0.05 seconds to 2 seconds. The mass ratio of steam to hydrocarbons may be from about 0.3:1 to about 2:1. Generally, steam cracking occurs in the absence of a catalyst.

Referring now to FIG. 2, another hydrogen transport system 102 is depicted. The hydrogen transport system 102 may be similar or identical to the hydrogen transport system 101 of FIG. 1, except where described otherwise. In particular, the hydrogen transport system 102 may pass multiple process streams between the first hydrocarbon processing facility 100 and second hydrocarbon processing facility 200. For example, FIG. 2 utilizes different processing of light gas stream 151 and heavy naphtha stream 153. Light gas stream 151 and heavy naphtha stream 153 may be transported to the second hydrocarbon processing facility 200. It should be noted that the transportation of heavy naphtha stream 153 is substantially similar to the transportation of light naphtha stream 152. However, the transportation of light gas stream 151 may require compression or liquefaction of the light gas stream 151 before and during transportation.

In embodiments, one or more of the hydrogenated hydrocarbon cuts 150 may be further hydrocracked in a second hydrocracker (not depicted in the figures) before being transported from the first hydrocarbon processing facility 100 to the second hydrocarbon processing facility. Hydrocracking the one or more of the hydrogenated hydrocarbon cuts 150 may increase the concentration of hydrogen atoms and/or the concentration of C₂-C₄ hydrocarbons in the one or more of the hydrogenated hydrocarbon cuts 150. The C₂-C₄ hydrocarbons may be desired as dehydrogenating C₂-C₄ hydrocarbons may result in the production of valuable olefin chemicals including ethylene, propylene, and butylene, in addition to the hydrogen gas released. The second hydrocracker (not depicted in the figures) may operate under substantially the same conditions as the hydrocracker 120.

According to some embodiments, at least a fraction of light gas stream 151 comprising ethane may be passed to an ethane steam cracker (not shown in the figures), thereby producing ethylene and hydrogen gas. The fraction of the light gas stream 151 comprising ethane may comprise at least 80 wt. %, at least 90 wt. %, or at least 99 wt. % of ethane, on the basis of the fraction of the light gas stream 151 comprising ethane passed to the ethane steam cracker. The ethane steam cracker may convert ethane into ethylene and hydrogen by contacting ethylene with steam at ethane steam cracking conditions. Ethane steam cracking conditions may include a temperature of from 800° C. to 1000° C. and a reaction time of less than 1 second, such as less than 0.5 seconds, less than 0.1 seconds, or less than 0.01 seconds.

According to some embodiments, at least a fraction of light gas stream 151 may be passed to a propane dehydrogenation unit 210, thereby producing a propylene stream 214 and a hydrogen gas stream 212 from propane. Hydrogen gas stream 212 may comprise at least 80 wt. %, at least 90 wt. %, at least 95 wt. %, at least 99 wt. %, at least 99.9 wt. %, or even at least 99.99 wt. % of hydrogen, on the basis of the total weight of hydrogen gas stream 212. Propylene stream 214 may comprise at least 80 wt. %, at least 90 wt. %, at least 95 wt. %, at least 99 wt. %, at least 99.9 wt. %, or even at least 99.99 wt. % of propylene, on the basis of the total weight of propylene stream 214.

According to some embodiments, at least a fraction of light gas stream 151 may be passed to butane dehydrogenation unit 220, thereby producing hydrogen gas stream 222 and butylene stream 224 from butane. Hydrogen gas stream 222 may comprise at least 80 wt. %, at least 90 wt. %, at least 95 wt. %, at least 99 wt. %, at least 99.9 wt. %, or even at least 99.99 wt. % of hydrogen, on the basis of the total weight of hydrogen gas stream 222. Butylene stream 224 may comprise at least 80 wt. %, at least 90 wt. %, at least 95 wt. %, at least 99 wt. %, at least 99.9 wt. %, or even at least 99.99 wt. % of butylene, on the basis of the total weight of butylene stream 224.

Together, processes for the dehydrogenation of lower alkanes (such as propane and butanes) are described as lower alkane dehydrogenation process. Processes for the dehydrogenation of lower alkanes include oxidative hydrogenation processes and non-oxidative dehydrogenation processes. In an oxidative dehydrogenation process, the process heat is provided by partial oxidation of the lower alkane(s) in the feed. In a non-oxidative dehydrogenation process, the process heat for the endothermic dehydrogenation reaction is provided by external heat sources such as hot flue gases obtained by burning of fuel gas or steam.

In embodiments, the propane dehydrogenation unit 210, the butane dehydrogenation unit 220, or both may operate at a temperature of from 300° C. to 800° C., such as from 300° C. to 400° C., from 400° C. to 500° C., from 500° C. to 600° C., from 600° C. to 700° C., from 700° C. to 800° C., or any combinations thereof. The propane dehydrogenation unit 210, the butane dehydrogenation unit 220, or both may also operate at a pressure of from 0.001 MPa to 1 MPa. Without being bound by any particular theory, it is believed that since the dehydrogenation of hydrocarbons is an endothermic reaction and conversion levels are limited by chemical equilibrium, it may be desirable to operate at relatively high temperatures and relatively low hydrogen partial pressures in order to achieve greater conversion.

In embodiments, the propane dehydrogenation unit 210, the butane dehydrogenation unit 220, or both may also include a catalyst system for conversion of hydrocarbons. The catalyst system may include a dehydrogenation catalyst, such as, an alumina, silica, zirconia, or amorphous silica-alumina support material, one or more alkali or alkaline earth metals, and/or one or more platinum group metals. In some embodiments, the dehydrogenation catalyst may comprise Pt and/or Cr with alkali or alkaline earth metals and an alumina support. Dehydrogenating propane, butane, or both may further include contacting the propane, butane, or both hydrocarbons with the catalyst system to dehydrogenate at least a portion of the propane, butane, or both into the propylene and/or butylene.

According to some embodiments, at least a fraction of light naphtha stream 152 may be passed to aromatization unit 240, thereby producing hydrogen gas stream 242 and aromatized stream 244. Hydrogen gas stream 242 may comprise at least 80 wt. %, at least 90 wt. %, at least 95 wt. %, at least 99 wt. %, at least 99.9 wt. %, or even at least 99.99 wt. % of hydrogen, on the basis of the total weight of hydrogen gas stream 242. Aromatized stream 244 may comprise at least 80 wt. %, at least 90 wt. %, at least 95 wt. %, at least 99 wt. %, at least 99.9 wt. %, or even at least 99.99 wt. % of aromatic hydrocarbons, on the basis of the total weight of aromatized stream 244.

The aromatization unit 240 may contact the hydrocarbons with an aromatization catalyst under aromatization conditions, such as a temperature of from 200° C. to 600° C., a pressure of from 1 to 315 pounds per square inch (PSI), and a liquid hourly space velocity (LHSV) of 0.1 h⁻¹ to 100 h⁻¹. Some aromatization catalysts comprise a Group VIII deposited metal, such as platinum, and elements other than silicon and aluminum, such as germanium, in the zeolite crystalline framework.

According to some embodiments, heavy naphtha stream 153 may be passed to naphtha reformer 250, thereby producing hydrogen gas stream 252 and reformed naphtha stream 254. Naphtha reforming refers to a process of catalytically reforming hydrocarbons to produce isomerized hydrocarbons and hydrogen gas. The naphtha reformer 250 may operate at a reaction temperature of from 300° C. to 700° C., such as from 300° C. to 400° C., from 400° C. to 500° C., from 500° C. to 600° C., from 600° C. to 700° C., from 400° C. to 600° C., or any combination of one or more of these ranges; a reaction pressure of from 1 bar to 50 bar, such as from 1 bar to 30 bar, from 1 bar to 20 bar, from 1 bar to 10 bar, from 5 bar to 50 bar, from 10 bar to 50 bar, from 20 bar to 50 bar, from 30 bar to 50 bar, or any combination of one or more of these ranges; and a liquid hourly space velocity (LHSV) of from 0.5 h⁻¹ to 5 h⁻¹, such as from 0.5 h⁻¹ to 4 h⁻¹, from 0.5 h⁻¹ to 3 h⁻¹, from 0.5 h⁻¹ to 2 h⁻¹, from 0.5 h⁻¹ to 1 h⁻¹, from 1 h⁻¹ to 5 h⁻¹, from 2 h⁻¹ to 5 h⁻¹, from 3 h⁻¹ to 5 h⁻¹, from 4 h⁻¹ to 5 h⁻¹, or any combination of one or more of these ranges. The naphtha reforming may occur in the presence of a naphtha reforming catalyst such as a noble metal (Pt or Re) supported on a silica, alumina, or silica-alumina base.

Still referring to FIG. 2, one or more streams may be discharged to a location outside the second hydrocarbon processing facility 200. For example, one or more of hydrogen gas stream 212, hydrogen gas stream 222, hydrogen gas stream 232, hydrogen gas stream 242, hydrogen gas stream 252, propylene stream 214, butylene stream 224, steam cracked stream 234, aromatized stream 244, and reformed naphtha stream 254 may be discharged.

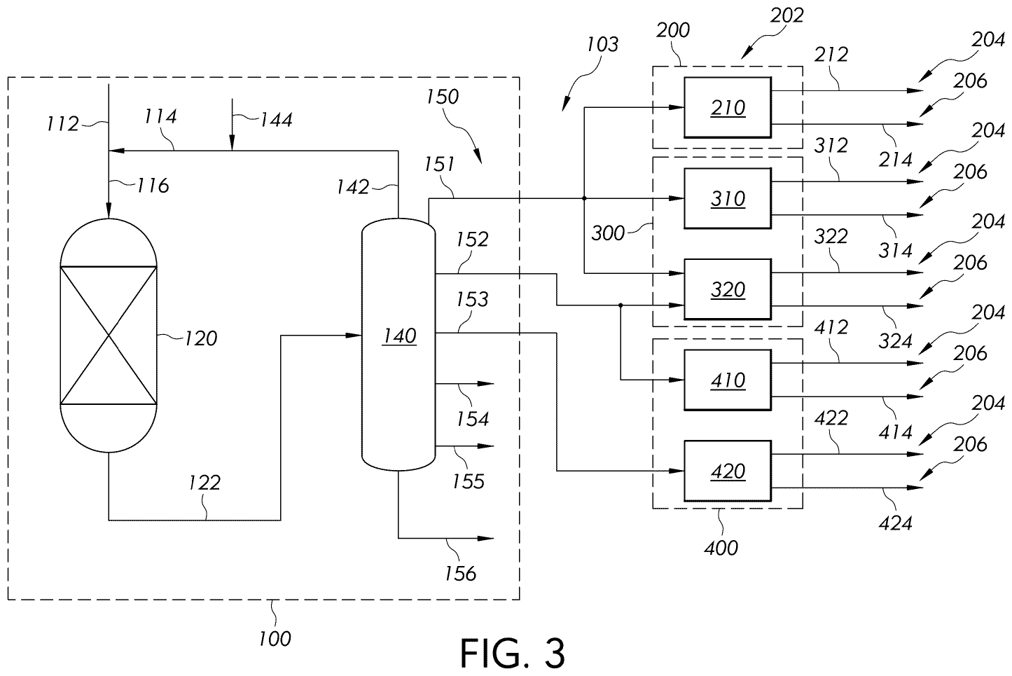

Referring now to FIG. 3, another hydrogen transport system 103 is depicted. The hydrogen transport system 103 may be similar or identical to the hydrogen transport system 102 of FIG. 2, except where described otherwise. In particular, light gas stream 151 or portions thereof, light naphtha stream 152 or portions thereof, and heavy naphtha stream 153 may be transported to separate hydrocarbon processing facilities for dehydrogenation. For example, a portion of light gas stream 151 may be transported to a third hydrocarbon processing facility 300. At the third hydrocarbon processing facility 300, a portion of the light gas stream 151 may be introduced to butane dehydrogenation unit 310, thereby producing hydrogen gas stream 312 and butylene stream 314. Butane dehydrogenation unit 310 may be substantially similar to butane dehydrogenation unit 220. Hydrogen gas stream 312 may be substantially similar to hydrogen gas stream 222. Butylene stream 314 may be substantially similar to butylene stream 224.

The third hydrocarbon processing facility 300 may comprise any new or conventional hydrocarbon processing facility capable of dehydrogenating one or more hydrogenated hydrocarbon cuts 150. For example, the third hydrocarbon processing facility 300 may be an oil refinery. The third hydrocarbon processing facility 300 may comprise any of the dehydrogenation units discussed herein (a propane dehydrogenation unit, a butane dehydrogenation unit, a steam cracker, an aromatization unit, or a naphtha reformer). For example, the third hydrocarbon processing facility 300 may include a butane dehydrogenation unit 310 and a steam cracker 320.

The first hydrocarbon processing facility 100 and the third hydrocarbon processing facility 300 may be separate from one another. For example, the first hydrocarbon processing facility 100 and the third hydrocarbon processing facility 300 may be at least 100 km apart from one another, such as at least 200 km, at least 500 km, or at least 1000 km. In embodiments, the first hydrocarbon processing facility 100 and the third hydrocarbon processing facility 300 may reside at different latitudes or in different time zones.

Transporting the at least one of the hydrogenated hydrocarbon cuts 150 may comprise transporting the at least one of the hydrogenated hydrocarbon cuts 150 from the first hydrocarbon processing facility 100 to the third hydrocarbon processing facility 300. The at least one of the hydrogenated hydrocarbon cuts 150 may be transported from the first hydrocarbon processing facility 100 to the third hydrocarbon processing facility 300 by tanker truck, train, ship, and/or pipeline. In embodiments, the hydrocarbons may be transported from the first hydrocarbon processing facility 100 to the third hydrocarbon processing facility 300 by tanker truck, train, and/or ship.

In some embodiments, at least a portion of light naphtha stream 152 and heavy naphtha stream 153 may be transported to a fourth hydrocarbon processing facility 400. At the fourth hydrocarbon processing facility 400, the light naphtha stream 152 may be passed to aromatization unit 410, thereby producing hydrogen gas stream 412 and aromatized stream 414. Aromatization unit 410 may be substantially similar to aromatization unit 240. Hydrogen gas stream 412 may be substantially similar to hydrogen gas stream 242. Aromatized stream 414 may be substantially similar to aromatized stream 244. At the fourth hydrocarbon processing facility 400, the heavy naphtha stream 153 may be passed to naphtha reformer 420, thereby producing hydrogen gas stream 422 and reformed naphtha stream 424. Naphtha reformer 420 may be substantially similar to naphtha reformer 250. Hydrogen gas stream 422 may be substantially similar to hydrogen gas stream 252. Reformed naphtha stream 424 may be substantially similar to reformed naphtha stream 254.

The fourth hydrocarbon processing facility 400 may comprise any new or conventional hydrocarbon processing facility capable of dehydrogenating one or more hydrogenated hydrocarbon cuts 150. For example, the fourth hydrocarbon processing facility 400 may be an oil refinery. The fourth hydrocarbon processing facility 400 may comprise any of the dehydrogenation units discussed herein (a propane dehydrogenation unit, a butane dehydrogenation unit, a steam cracker, an aromatization unit, or a naphtha reformer). For example, the fourth hydrocarbon processing facility 400 may include an aromatization unit 410 and a naphtha reformer 420.

The first hydrocarbon processing facility 100 and the fourth hydrocarbon processing facility 400 may be separate from one another. For example, the first hydrocarbon processing facility 100 and the fourth hydrocarbon processing facility 400 may be at least 100 km apart from one another, such as at least 200 km, at least 500 km, or at least 1000 km. In embodiments, the first hydrocarbon processing facility 100 and the fourth hydrocarbon processing facility 400 may reside at different latitudes or different time zones.

Transporting the at least one of the hydrogenated hydrocarbon cuts 150 may comprise transporting the at least one of the hydrogenated hydrocarbon cuts 150 from the first hydrocarbon processing facility 100 to the fourth hydrocarbon processing facility 400. The at least one of the hydrogenated hydrocarbon cuts 150 may be transported from the first hydrocarbon processing facility 100 to the fourth hydrocarbon processing facility 400 by tanker truck, train, ship, and/or pipeline. In embodiments, the hydrocarbons may be transported from the first hydrocarbon processing facility 100 to the fourth hydrocarbon processing facility 400 by tanker truck, train, and/or ship.

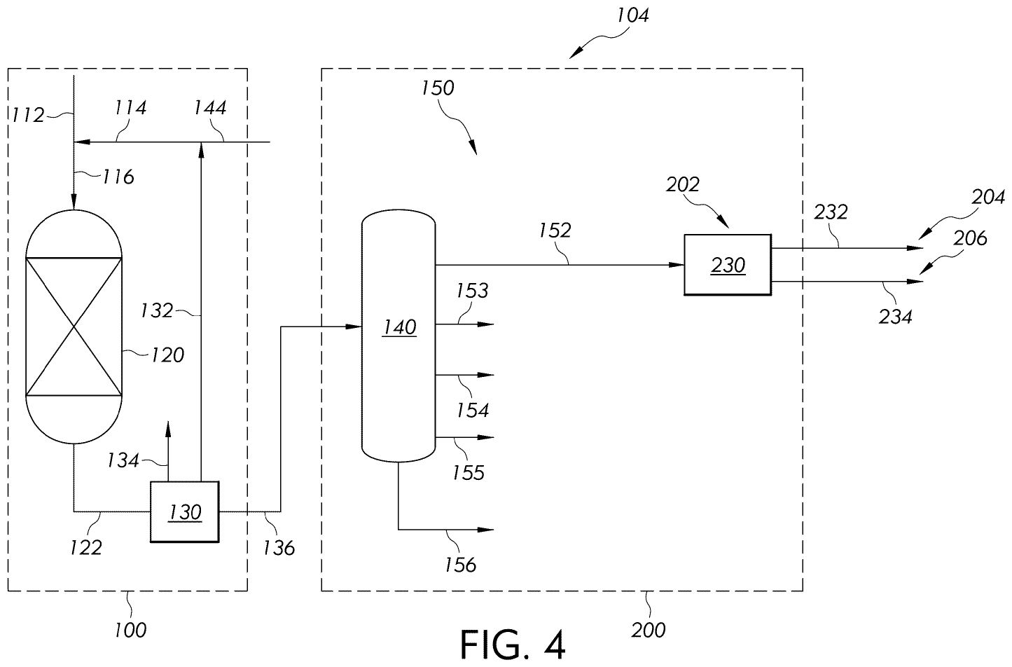

Referring now to FIG. 4, another hydrogen transport system 104 is depicted. The hydrogen transport system 104 may be similar or identical to the hydrogen transport system 101 of FIG. 1, except where described otherwise. In particular, a portion of hydrocracked effluent 122 may be transported from the first hydrocarbon processing facility 100 to the second hydrocarbon processing facility 200. Further, the separation unit 140 may be located at the second hydrocarbon processing facility 200, instead the first hydrocarbon processing facility 100.

Before transporting the portion of the hydrocracked effluent 122 from the first hydrocarbon processing facility 100 to the second hydrocarbon processing facility 200, the hydrocracked effluent 122 may be passed to a separation unit 130 to form a hydrogen recycle stream 132 comprising H₂ gas, a light hydrocarbon stream 134 comprising C₂-C₄ hydrocarbons, and a heavy hydrocarbon stream 136 comprising C₅₊ hydrocarbons. The separation unit 130 may be any separation unit operable to separate chemical components by boiling point, such as a flash drum or series of flash drums. The heavy hydrocarbon stream 136 may be transported to the second hydrocarbon processing facility 200 for separation in separation unit 140. The hydrogen recycle stream 132 may be recycled back to the hydrocracker 120. The light hydrocarbon stream 134 may be transported to the second hydrocarbon processing facility 200, or another hydrocarbon processing facility, for processing as described herein.

The hydrogen recycle stream 132 may comprise at least 80 wt. %, such as at least 90 wt. %, at least 95 wt. %, or at least 99 wt. % of H₂ gas, on the basis of the total weight of the hydrogen recycle stream 132. The light hydrocarbon stream 134 may comprise 80 wt. %, such as at least 90 wt. %, at least 95 wt. %, or at least 99 wt. % of C₂-C₄ hydrocarbons, on the basis of the total weight of the light hydrocarbon stream 134. The heavy hydrocarbon stream 136 may comprise at least 80 wt. %, such as at least 90 wt. %, at least 95 wt. %, or at least 99 wt. % of C₅₊ hydrocarbons, on the basis of the total weight of the heavy hydrocarbon stream 136.

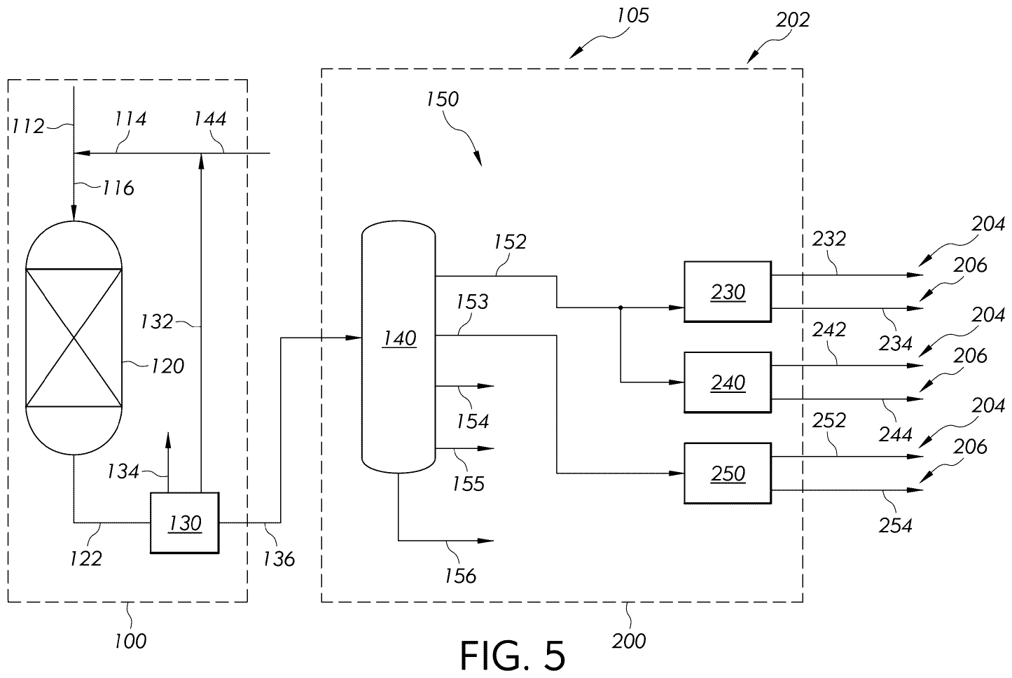

Referring now to FIG. 5, another hydrogen transport system 105 is depicted. The hydrogen transport system 105 may be similar or identical to the hydrogen transport system 102 of FIG. 2, except where described otherwise. In particular, a portion of the hydrocracked effluent 122 may be transported from the first hydrocarbon processing facility 100 to the second hydrocarbon processing facility 200. Further, the separation unit 140 may be located at the second hydrocarbon processing facility 200, instead the first hydrocarbon processing facility 100.

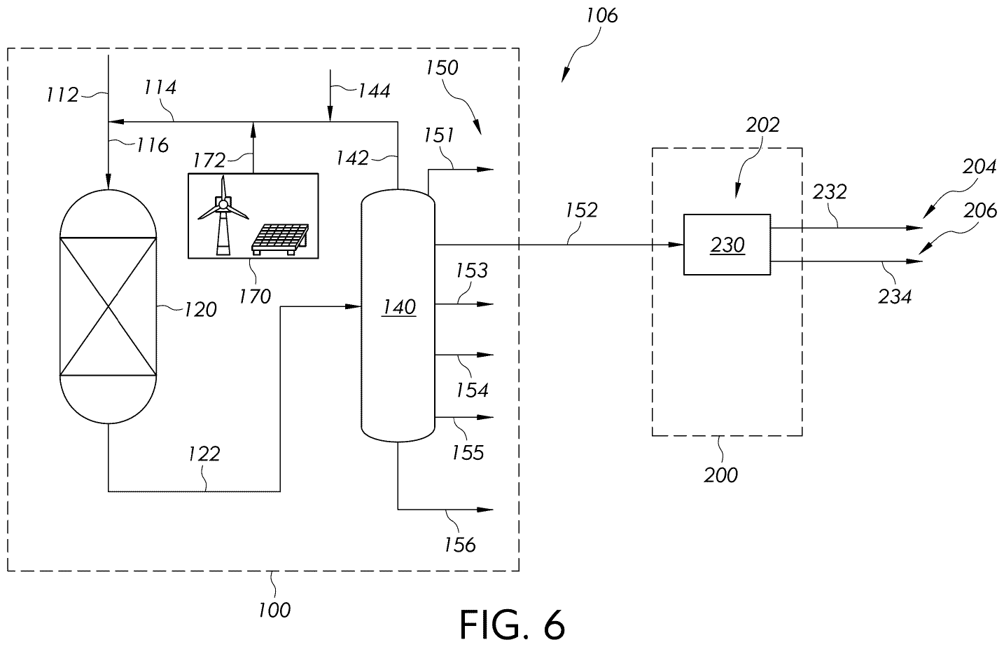

Referring now to FIG. 6, another hydrogen transport system 106 is depicted. The hydrogen transport system 106 may be similar or identical to the hydrogen transport system 101 of FIG. 1, except where described otherwise. In particular, a second makeup hydrogen stream 172 may be included. As mentioned previously, the hydrogen recycle stream 142 may be supplemented with a makeup hydrogen stream 144. In some embodiments, a second makeup hydrogen stream 172 may also be combined with the hydrogen recycle stream 142 and the makeup hydrogen stream 144 to produce the combined hydrogen feed 114. The second makeup hydrogen stream 172 may comprise renewable hydrogen, such as at least 80 mol. %, at least 90 mol. %, at least 99 mol. %, or even 100 mol. % of renewable hydrogen, on the basis of the total weight of the second makeup hydrogen stream 172. Renewable hydrogen may refer to hydrogen produced from water electrolysis using electricity produced from sources other than the combustion of hydrocarbons. For example, the electricity for the electrolysis process may be produced from solar power, wind power, geothermal power, or hydroelectric power. In some embodiments, the makeup hydrogen stream 144 may comprise hydrogen gas produced from hydrocarbons, such as through hydrocarbon gasification and water-gas shift reactions.

In some embodiments, where both renewable hydrogen and hydrogen produced from hydrocarbons are present, the amount of renewable hydrogen introduced to the hydrocracker 120 may be greater than or equal to the amount of hydrogen released through the dehydrogenation reactions, per ton of hydrocarbon feed. For example, if the total hydrogen released through the dehydrogenation reactions is 1 kg hydrogen/10 kg hydrocarbon feed, then at least 1 kg of renewable hydrogen per 10 kg hydrocarbon feed may be introduced to the hydrocracker 120.

One conventional method of storing and transporting hydrogen is through the use of so called liquid organic hydrogen carriers (“LOHCs”). In a conventional LOHC process, aromatic hydrocarbons are hydrogenated at a hydrogenation location, transferred to a dehydrogenation location, then dehydrogenated to produce hydrogen and recover the aromatic hydrocarbons. The aromatic hydrocarbons are then returned to the hydrogenation location for reuse. However, the relatively limited supply of aromatic compounds and the need to return the aromatic compounds to the first location imposes significant costs on the LOHC process. Embodiments of the present disclosure may allow the transportation of hydrogen without the use of these aromatic compounds and/or without the need to recycle compounds back to hydrogenation location.

Numerous aspects are presently disclosed herein, including Aspects 1-20.

Aspect 1. A method of transporting hydrogen, the method comprising: at a first hydrocarbon processing facility, hydrocracking a hydrocarbon feed in the presence of hydrogen gas to form a hydrocracked effluent, wherein the hydrocracked effluent has a greater ratio of hydrogen to carbon than the hydrocarbon feed; at the first hydrocarbon processing facility, separating the hydrocracked effluent into two or more hydrogenated hydrocarbon cuts; transporting one or more of the hydrogenated hydrocarbon cuts from the first hydrocarbon processing facility to a second hydrocarbon processing facility, wherein the first hydrocarbon processing facility and the second hydrocarbon processing facility are at least 100 km apart from one another; and at the second hydrocarbon processing facility, dehydrogenating one or more of the hydrogenated hydrocarbon cuts to form hydrogen gas and one or more dehydrogenated hydrocarbon cuts.

Aspect 2. The method of aspect 1, wherein: separating the hydrocracked effluent produces a light gas stream comprising C1-C4 hydrocarbons, a light naphtha stream, and a heavy naphtha stream; and one or more of the light gas stream, the light naphtha stream, or the heavy naphtha stream are dehydrogenated at the second hydrocarbon processing facility.

Aspect 3. The method of aspects 1-2, further comprising: transporting one or more of the hydrogenated hydrocarbon cuts from the first hydrocarbon processing facility to a third hydrocarbon processing facility; and at the third hydrocarbon processing facility, dehydrogenating one or more of the hydrogenated hydrocarbon cuts to form hydrogen gas and one or more dehydrogenated hydrocarbon cuts.

Aspect 4. The method of aspects 1-3, wherein the hydrocarbon feed comprises a crude oil, a naphtha, a diesel range hydrocarbon fraction, a jet fuel range hydrocarbon fraction, a vacuum gas oil, or an atmospheric residue.

Aspect 5. The method of aspects 1-4, further comprising: separating a crude oil in an atmospheric distillation unit, thereby producing an atmospheric bottoms stream; and separating the atmospheric bottoms stream in a vacuum distillation unit, thereby producing a vacuum gas oil, wherein the hydrocarbon feed comprises the vacuum gas oil.

Aspect 6. The method of aspects 1-5, wherein the one or more hydrogenated hydrocarbon cuts comprise linear alkanes.

Aspect 7. The method of aspects 1-6, wherein the separating the hydrocracked effluent produces at least: a light gas stream comprising C2-C4 hydrocarbons; a light naphtha stream; and a heavy naphtha stream.

Aspect 8. The method of aspects 1-7, the method further comprising discharging the one or more dehydrogenated hydrocarbon cuts from the second hydrocarbon processing facility.

Aspect 9. The method of aspects 1-8, wherein dehydrogenating the hydrogenated hydrocarbon cuts comprises one or more of propane dehydrogenation, butane dehydrogenation, steam cracking, aromatization, or naphtha reforming.

Aspect 10. The method of aspects 1-9, wherein the transporting of one or more of the hydrogenated hydrocarbon cuts comprises moving the one or more hydrogenated hydrocarbon cuts by rail, truck, or by ship.

Aspect 11. A method of transporting hydrogen, the method comprising: at a first hydrocarbon processing facility, hydrocracking a hydrocarbon feed in the presence of hydrogen gas to form a hydrocracked effluent, wherein the hydrocracked effluent has a greater ratio of hydrogen to carbon than the hydrocarbon feed; separating the hydrocracked effluent into at least a hydrogen recycle stream comprising hydrogen gas and a heavy hydrocarbon stream comprising C₅₊ hydrocarbons; transporting the heavy hydrocarbon stream from the first hydrocarbon processing facility to a second hydrocarbon processing facility, wherein the first hydrocarbon processing facility and the second hydrocarbon processing facility are at least 100 km apart from one another; at the second hydrocarbon processing facility, separating the heavy hydrocarbon stream into two or more hydrogenated hydrocarbon cuts; and at the second hydrocarbon processing facility, dehydrogenating one or more of the hydrogenated hydrocarbon cuts to form hydrogen gas and one or more dehydrogenated hydrocarbon cuts.

Aspect 12. The method of aspects 11, wherein: separating the heavy hydrocarbon stream produces at least a light naphtha stream and a heavy naphtha stream; and the light naphtha stream, the heavy naphtha stream, or both are dehydrogenated at the second hydrocarbon processing facility.

Aspect 13. The method of aspects 11-12, the hydrocarbon feed comprises a crude oil, a naphtha, a diesel range hydrocarbon fraction, a jet fuel range hydrocarbon fraction, a vacuum gas oil, or an atmospheric residue.

Aspect 14. The method of aspects 11-13, wherein the one or more hydrogenated hydrocarbon cuts comprise linear alkanes.

Aspect 15. The method of aspects 11-14, the method further comprising discharging the one or more dehydrogenated hydrocarbon cuts from the second hydrocarbon processing facility.

Aspect 16. The method of aspects 11-15, wherein dehydrogenating the hydrogenated hydrocarbon cuts comprises one or more of steam cracking, aromatization, or naphtha reforming.

Aspect 17. The method of aspects 11-16, wherein the transporting the heavy hydrocarbon stream comprises moving the heavy hydrocarbon stream by rail, truck, or ship.

Aspect 18. The method of aspects 12-17, wherein dehydrogenating the light naphtha stream comprises steam cracking at least a portion of the light naphtha stream.

Aspect 19. The method of aspects 12-18, wherein dehydrogenating the light naphtha stream comprises aromatization of at least a portion of the light naphtha stream.

Aspect 20. The method of aspects 12-19, wherein dehydrogenating the heavy naphtha stream comprises naphtha reforming of at least a portion of the heavy naphtha stream.

For the purposes of describing and defining the present disclosure it is noted that the terms “about” or “approximately” are utilized in this disclosure to represent the inherent degree of uncertainty that may be attributed to any quantitative comparison, value, measurement, or other representation. The terms “about” and/or “approximately” are also utilized in this disclosure to represent the degree by which a quantitative representation may vary from a stated reference without resulting in a change in the basic function of the subject matter at issue.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

Any quantitative value expressed in the present application may be considered to include open-ended embodiments consistent with the transitional phrases “comprising” or “including” as well as closed or partially closed embodiments consistent with the transitional phrases “consisting of” and “consisting essentially of.”

It is also noted that recitations herein of “at least one” component, element, etc., should not be used to create an inference that the alternative use of the articles “a” or “an” should be limited to a single component, element, etc.

What is claimed is:

1. A method of transporting hydrogen, the method comprising:
at a first hydrocarbon processing facility, hydrocracking a hydrocarbon feed in the presence of hydrogen gas to form a hydrocracked effluent, wherein the hydrocracked effluent has a greater ratio of hydrogen to carbon than the hydrocarbon feed;
at the first hydrocarbon processing facility, separating the hydrocracked effluent into two or more hydrogenated hydrocarbon cuts;
transporting one or more of the hydrogenated hydrocarbon cuts from the first hydrocarbon processing facility to a second hydrocarbon processing facility, wherein the first hydrocarbon processing facility and the second hydrocarbon processing facility are at least 100 km apart from one another; and
at the second hydrocarbon processing facility, dehydrogenating one or more of the hydrogenated hydrocarbon cuts to form hydrogen gas and one or more dehydrogenated hydrocarbon cuts.

2. The method of claim 1, wherein:
separating the hydrocracked effluent produces a light gas stream comprising C₁-C₄ hydrocarbons, a light naphtha stream, and a heavy naphtha stream; and
one or more of the light gas stream, the light naphtha stream, or the heavy naphtha stream are dehydrogenated at the second hydrocarbon processing facility.

3. The method of claim 1, further comprising:
transporting one or more of the hydrogenated hydrocarbon cuts from the first hydrocarbon processing facility to a third hydrocarbon processing facility; and
at the third hydrocarbon processing facility, dehydrogenating one or more of the hydrogenated hydrocarbon cuts to form hydrogen gas and one or more dehydrogenated hydrocarbon cuts.

4. The method of claim 1, wherein the hydrocarbon feed comprises a crude oil, a naphtha, a diesel range hydrocarbon fraction, a jet fuel range hydrocarbon fraction, a vacuum gas oil, or an atmospheric residue.

5. The method of claim 1, further comprising:
separating a crude oil in an atmospheric distillation unit, thereby producing an atmospheric bottoms stream; and
separating the atmospheric bottoms stream in a vacuum distillation unit, thereby producing a vacuum gas oil, wherein the hydrocarbon feed comprises the vacuum gas oil.

6. The method of claim 1, wherein the one or more hydrogenated hydrocarbon cuts comprise linear alkanes.

7. The method of claim 1, wherein the separating the hydrocracked effluent produces at least:
a light gas stream comprising C₂-C₄ hydrocarbons;
a light naphtha stream; and
a heavy naphtha stream.

8. The method of claim 1, the method further comprising discharging the one or more dehydrogenated hydrocarbon cuts from the second hydrocarbon processing facility.

9. The method of claim 1, wherein dehydrogenating the hydrogenated hydrocarbon cuts comprises one or more of propane dehydrogenation, butane dehydrogenation, steam cracking, aromatization, or naphtha reforming.

10. The method of claim 1, wherein the transporting of one or more of the hydrogenated hydrocarbon cuts comprises moving the one or more hydrogenated hydrocarbon cuts by rail, truck, or by ship.

11. A method of transporting hydrogen, the method comprising:
at a first hydrocarbon processing facility, hydrocracking a hydrocarbon feed in the presence of hydrogen gas to form a hydrocracked effluent, wherein the hydrocracked effluent has a greater ratio of hydrogen to carbon than the hydrocarbon feed;
separating the hydrocracked effluent into at least a hydrogen recycle stream comprising hydrogen gas and a heavy hydrocarbon stream comprising C₅₊ hydrocarbons;
transporting the heavy hydrocarbon stream from the first hydrocarbon processing facility to a second hydrocarbon processing facility, wherein the first hydrocarbon processing facility and the second hydrocarbon processing facility are at least 100 km apart from one another;
at the second hydrocarbon processing facility, separating the heavy hydrocarbon stream into two or more hydrogenated hydrocarbon cuts; and
at the second hydrocarbon processing facility, dehydrogenating one or more of the hydrogenated hydrocarbon cuts to form hydrogen gas and one or more dehydrogenated hydrocarbon cuts.

12. The method of claim 11, wherein:
separating the heavy hydrocarbon stream produces at least a light naphtha stream and a heavy naphtha stream; and
the light naphtha stream, the heavy naphtha stream, or both are dehydrogenated at the second hydrocarbon processing facility.

13. The method of claim 11, the hydrocarbon feed comprises a crude oil, a naphtha, a diesel range hydrocarbon fraction, a jet fuel range hydrocarbon fraction, a vacuum gas oil, or an atmospheric residue.

14. The method of claim 11, wherein the one or more hydrogenated hydrocarbon cuts comprise linear alkanes.

15. The method of claim 11, the method further comprising discharging the one or more dehydrogenated hydrocarbon cuts from the second hydrocarbon processing facility.

16. The method of claim 11, wherein dehydrogenating the hydrogenated hydrocarbon cuts comprises one or more of steam cracking, aromatization, or naphtha reforming.

17. The method of claim 11, wherein the transporting the heavy hydrocarbon stream comprises moving the heavy hydrocarbon stream by rail, truck, or ship.

18. The method of claim 12, wherein dehydrogenating the light naphtha stream comprises steam cracking at least a portion of the light naphtha stream.

19. The method of claim 12, wherein dehydrogenating the light naphtha stream comprises aromatization of at least a portion of the light naphtha stream.

20. The method of claim 12, wherein dehydrogenating the heavy naphtha stream comprises naphtha reforming of at least a portion of the heavy naphtha stream.
